(19) United States
(12) Patent Application Publication
(10) Pub. No.: US 2019/0222060 A1
(43) Pub. Date: Jul. 18, 2019

(54) WIRELESS POWER TRANSMITTER AND RECEIVER

(71) Applicant: LG INNOTEK CO., LTD., Seoul (KR)

(72) Inventor: Sung Hyun LEEM, Seoul (KR)

(73) Assignee: LG INNOTEK CO., LTD., Seoul (KR)

(21) Appl. No.: 16/308,202

(22) PCT Filed: Jun. 5, 2017
(86) PCT No.: PCT/KR2017/005867

§ 371 Date: Dec. 7, 2018

(30) Foreign Application Priority Data
Jun. 15, 2016 (KR) 10-2016-0074757
Jun. 15, 2016 (KR) 10-2016-0074759
Jul. 6, 2016 (KR) 10-2016-0085572

(51) Int. Cl. H02J 50/10; G06F 1/18; G06F 1/16

(52) U.S. Cl. CPC H02J 50/10; G06F 1/1683; G06F 1/182

(57) ABSTRACT

The invention relates to a wireless power transmitter and a wireless power receiver. A wireless power transmitter for wirelessly transmitting power to a wireless power receiver comprises a control circuit configured to control the wireless power transmitter, at least one transmission coil configured to transmit the power to the wireless power receiver, and a shielding member disposed between the transmission coil and the control circuit. The shielding member is a sheet in which a heat release sheet and a shielding sheet are combined.

### TECHNICAL FIELD

The invention relates to a wireless power transmitter and a wireless power receiver.

### BACKGROUND ART

Generally, various electronic apparatuses are equipped with a battery and are driven by using electric power charged in the battery. At this time, in the electronic device, the battery can be replaced and charged again. To this end, the electronic device has a contact terminal for contacting an external charging device. That is, the electronic device is electrically connected to the charging device through the contact terminal. However, as the contact terminal is exposed to the outside in the electronic device, it may be contaminated by foreign matter or short-circuited by moisture. In this case, there is a problem that a contact failure occurs between the contact terminal and the charging device, and the battery is not charged in the electronic device.

In order to solve the above problem, a wireless power transfer (WPT) for wirelessly charging an electronic device has been proposed. The wireless power transmission system is a technology that delivers power without wires through space, maximizing the convenience of power supply to mobile devices and digital home appliances. The wireless power transmission system has advantages such as saving energy through real-time power usage control, overcoming space limitation of power supply, and reducing waste battery discharge using battery recharging.

As a method of implementing a wireless power transmission system, there are typically a magnetic induction type and a self-resonance type. The magnetic induction method is a noncontact energy transmission technique in which two coils are brought close to each other, a current is supplied to one coil, and an electromotive force is generated in the other coil via the magnetic flux generated thereby. The self-resonance method is a magnetic resonance technique that uses only electric fields or magnetic fields without using electromagnetic waves or currents. The distance over which power can be transmitted is several meters or more, and a band of several MHz can be used.

The wireless power transmission system includes a transmitting device for transmitting power wirelessly and a receiving device for receiving power to charge a load such as a battery. At this time, there has been developed a transmitting apparatus capable of selecting a charging system of a receiving apparatus, that is, a charging system of either a magnetic induction system or a self-resonance system, and capable of wirelessly transmitting power corresponding to a charging system of a receiving apparatus.

### DISCLOSURE

### Technical Problem

A wireless power transmitter according to an embodiment includes a sheet in which a heat release sheet and a shielding sheet are chemically combined.

A wireless power receiver according to an embodiment includes one sheet in which a heat release sheet and a shielding sheet are chemically combined.

A wireless power transmitter according to an embodiment includes a shielding member including a plurality of protruding patterns.

A wireless power receiver according to an embodiment includes a shielding member including a plurality of protruding patterns.

A wireless power transmitter according to an embodiment includes a shielding member including a plurality of protruding patterns.

A wireless power receiver according to an embodiment includes a shielding member including a plurality of protruding patterns.

### Technical Solution

According to an embodiment, a wireless power transmitter for wirelessly transmitting power to a wireless power receiver includes: a control circuit configured to control the wireless power transmitter; at least one transmission coil configured to transmit the power to the wireless power receiver; and a shielding member disposed between the transmission coil and the control circuit, wherein the shielding member is a sheet in which a heat release sheet and a shielding sheet are combined.

According to another embodiment, a wireless power receiver for wirelessly receiving power from a wireless power transmitter includes: a control circuit configured to control the wireless power receiver; at least one receiving coil configured to receive the power from the wireless power transmitter; and a shielding member disposed between the receiving coil and the control circuit, wherein the shielding member is a sheet in which a heat release sheet and a shielding sheet are combined.

According to another embodiment, a wireless power transmitter for wirelessly transmitting power to a wireless power receiver includes: a control circuit configured to control the wireless power transmitter; at least one transmission coil configured to transmit the power to the wireless power receiver; and a shielding sheet disposed between the transmission coil and the control circuit, wherein the shielding sheet includes a plurality of protruding patterns on at least one surface of the upper surface and the lower surface.

According to another embodiment, a wireless power receiver for wirelessly transmitting power to a wireless power transmitter includes: a control circuit configured to control the wireless power receiver; at least one receiving coil configured to receive the power from the wireless power transmitter; and a shielding sheet disposed between the receiving coil and the control circuit, wherein the shielding sheet includes a plurality of protruding patterns on at least one surface of the upper surface and the lower surface.

According to another embodiment, a wireless power transmitter for wirelessly transmitting power to a wireless power receiver includes: a control circuit configured to control the wireless power transmitter; at least one transmission coil configured to transmit the power to the wireless power receiver; and a shielding sheet disposed between the transmission coil and the control circuit, wherein the shielding sheet includes a plurality of protruding patterns on at least one of an upper surface facing the control circuit and a lower surface not facing the control circuit and the area of the plurality of protruding patterns is 50% to 100% of the area of the shielding sheet.

According to another embodiment, a wireless power receiver for wirelessly transmitting power to a wireless power transmitter includes: a control circuit configured to control the wireless power receiver; at least one receiving coil configured to receive the power from the wireless power transmitter; and a shielding sheet disposed between the receiving coil and the control circuit, wherein the shielding sheet includes a plurality of protruding patterns on at least one of an upper surface facing the control circuit and a lower surface not facing the control circuit And the area of the plurality of protruding patterns is 50% to 100% of the area of the shielding sheet.

### Advantageous Effects

The wireless power transmitter and the receiver according to the embodiment can reduce the thickness of the sheet by using one sheet in which the heat release sheet and the shield sheet are chemically combined with each other than using each of the heat release sheet and the shielding sheet.

The wireless power transmitter and the receiver according to the embodiment use one sheet chemically combined with the heat release sheet and the shielding sheet so that the manufacturing cost can be reduced as compared with the case of using each of the heat release sheet and the shielding sheet.

The wireless power transmitter and the receiver according to the embodiment can maximize the receiving efficiency by using one sheet chemically combined with the heat release sheet and the shielding sheet to radiate heat generated when transmitting or receiving wireless power.

The wireless power transmitter according to the embodiment can improve the heat generating effect by using the shielding member including a plurality of protruding patterns.

The wireless power receiver according to the embodiment can improve the heat generating effect by using the shielding member including a plurality of protruding patterns.

A wireless power transmitter according to an embodiment includes a shielding member including a plurality of protruding patterns, and the shielding member having an area of the plurality of protruding patterns is 50% to 100% of the shielding member area.

A wireless power receiver according to an embodiment includes a shielding member including a plurality of protruding patterns, and the shielding member having an area of the plurality of protruding patterns of 50% to 100% of the shielding area is used to improve the releasing effect.

### DESCRIPTION OF DRAWINGS

FIG. 1 is a magnetic induction equivalent circuit.

FIG. 2 is a self-resonant-type equivalent circuit.

FIGS. 3A and 3B are block diagrams showing a transmitting apparatus as one of the subsystems constituting a wireless power transmission system.

FIGS. 4A and 4B are block diagrams illustrating a receiver as one of the subsystems constituting the wireless power transmission system.

FIG. 5 is a flowchart illustrating an operation of the wireless power transmission system.

FIG. 6 shows a shielding member according to an embodiment.

FIG. 7 shows a shielding member according to another embodiment.

FIG. 8 shows a control circuit and a shielding member included in a wireless power transmitter or a wireless power receiver according to another embodiment.

FIG. 9 shows a control circuit and a shielding member included in a wireless power transmitter or a wireless power receiver according to another embodiment.

FIG. 10 shows a control circuit and a shielding member included in a wireless power transmitter or a wireless power receiver according to another embodiment.

FIG. 11 shows a control circuit and a shielding member included in a wireless power transmitter or a wireless power receiver according to another embodiment.

FIG. 12 shows a control circuit and a shielding member included in a wireless power transmitter or a wireless power receiver according to another embodiment.

FIG. 13 shows a control circuit and a shielding member included in a wireless power transmitter or a wireless power receiver according to another embodiment.

FIG. 14 shows a pattern of a shielding member included in a wireless power transmitter or a wireless power receiver according to an embodiment.

FIG. 15 shows a pattern of a shielding member included in a wireless power transmitter or a wireless power receiver according to another embodiment.

16 illustrates a pattern of a shielding member included in a wireless power transmitter or a wireless power receiver according to another embodiment.

FIG. 17 illustrates a pattern of a shielding member included in a wireless power transmitter or a wireless power receiver according to another embodiment.

FIG. 18 shows a pattern of a shielding member included in a wireless power transmitter or a wireless power receiver according to another embodiment.

FIG. 19 shows a pattern of a shielding member included in a wireless power transmitter or a wireless power receiver according to another embodiment.

FIG. 20 shows a pattern of a shielding member included in a wireless power transmitter or a wireless power receiver according to another embodiment.

FIG. 21 shows a pattern of a shielding member included in a wireless power transmitter or a wireless power receiver according to another embodiment.

FIG. 22 illustrates a pattern of a shielding member included in a wireless power transmitter or a wireless power receiver according to another embodiment.

FIG. 23 illustrates a pattern of a shielding member included in a wireless power transmitter or a wireless power receiver according to another embodiment.

FIG. 24 illustrates a pattern of a shielding member included in a wireless power transmitter or a wireless power receiver according to another embodiment.

FIG. 25 illustrates a pattern of a shielding member included in a wireless power transmitter or a wireless power receiver according to another embodiment.

FIG. 26 shows a pattern of a shielding member included in a wireless power transmitter or a wireless power receiver according to another embodiment.

FIG. 27 illustrates a pattern of a shielding member included in a wireless power transmitter or a wireless power receiver according to another embodiment.

### MODE FOR INVENTION

Hereinafter, a wireless power transmission system including a transmitter having a function of transmitting power wirelessly and a receiver receiving power wirelessly according to an embodiment will be described in detail with reference to the drawings. The following embodiments are provided by way of example so that those skilled in the art can fully understand the spirit of the invention. Therefore, the invention is not limited to the embodiments described below, but may be embodied in other forms. In the drawings, the size and thickness of the device may be exaggerated for convenience. Like reference numerals designate like elements throughout the specification.

Embodiments may include a communication system that selectively uses various kinds of frequency bands from low frequency (50 kHz) to high frequency (15 MHz) for wireless power transmission and can exchange data and control signals for system control.

The embodiments can be applied to various industrial fields such as a mobile terminal industry using a battery or an electronic device required, a smart clock industry, a computer and notebook industry, a household appliance industry, an electric car industry, a medical device industry, and a robot industry.

Embodiments may consider a system capable of power transmission to one or more multiple devices using one or more transmission coils.

According to the embodiment, it is possible to solve the battery shortage problem in a mobile device such as a smart phone and a notebook. For example, when a wireless charging pad is placed on a table and a smart phone or a notebook is used on the table, the battery is automatically charged and can be used for a long time. In addition, by installing wireless charging pads in public places such as cafes, airports, taxis, offices, restaurants, etc., mobile devices manufacturers can charge various mobile devices regardless of charging terminals. When wireless power transmission technology is applied to household electrical appliances such as cleaners, electric fans, etc., there is no need to look for power cables, and complex wires can be eliminated in the home, which can reduce wiring in buildings and increase the space utilization. In addition, it takes a lot of time to charge the electric car with the current household power, but if the high power is transmitted through the wireless power transmission technology, the charging time can be reduced. If the wireless charging facility is installed at the bottom of the parking lot, it is possible to solve the inconvenience of having to prepare.

The terms and abbreviations used in the examples are as follows.

Wireless Power Transfer System: A system that provides wireless power transmission within a magnetic field region

Wireless Power Transfer System-Charger: A device that provides wireless power transmission to a power receiver within a magnetic field area and manages the entire system.

Wireless Power Transfer System-Device: A device that is provided with a wireless power transmission from a power transmitter within a magnetic field area.

Charging Area: An area where actual wireless power transmission occurs within the magnetic field area, and may vary depending on the size, required power, and operating frequency of the application product.

Scattering parameter: The Scattering parameter (S parameter) is the ratio of the input port to the output port in ratio of the input voltage to the output voltage on the frequency distribution (Transmission; S21) or the self reflection value of each input/output port, that is, output value that is reflected by self-input (Reflection; S11, S22).

Quality factor Q: The value of Q in resonance means the quality of frequency selection. The higher the Q value, the better the resonance characteristics. The Q value is expressed as the ratio of the energy stored in the resonator to the energy lost.

The principles of wireless power transmission include magnetic induction system and self-resonance system.

The magnetic induction method is a noncontact energy transfer technique in which an electromotive force is generated in the load inductor LI via a magnetic flux generated when the source inductor Ls and the load inductor LI are brought close to each other and a current is supplied to one of the source inductors Ls. The self-resonance method combines two resonators to generate self-resonance due to the natural frequency between two resonators. In this case, by resonating at the same frequency, resonance techniques are used to form an electric field and a magnetic field in the same wavelength range to wirelessly transmitting energy.

1 is a magnetic induction equivalent circuit.

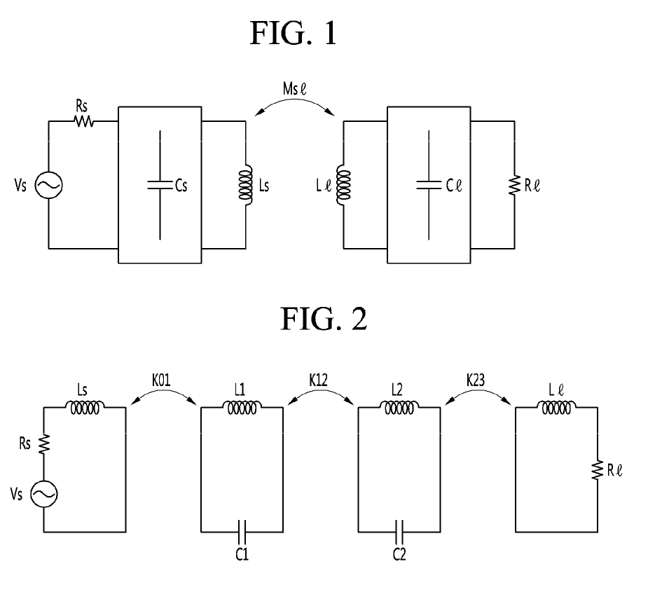

Referring to FIG. 1, in a magnetic induction equivalent circuit, a transmitter includes a source voltage Vs, a source resistance Rs, a source capacitor Cs for impedance matching, and a magnetic coupling with a receiver And a load coil RI for impedance matching, a load capacitor CI for impedance matching, and a load coil LI for magnetic coupling with a transmitter. And the degree of magnetic coupling between the source coil Ls and the load coil LI can be expressed by mutual inductance MsI.

In FIG. 1, the ratio S21 of the input voltage to the output voltage is obtained from the magnetic induction equivalent circuit consisting only of the coil only without the source capacitor Cs and the load capacitor CI for impedance matching, and the maximum power transmission condition satisfies the following equation 1.

Ls/Rs=LI/RI Equation 1

The maximum power transmission is possible when the ratio of the inductance of the transmission coil Ls to the source resistance Rs and the ratio of the inductance of the load coil LI to the load resistance RI are equal to each other. Since there is no capacitor that can compensate for reactance in a system with only inductance, the value of the self reflection value (S11) of the input/output port cannot be zero at the point where the maximum power transfer is made and the mutual inductance MsI), the power transmission efficiency may vary greatly. Thus, the source capacitor Cs can be added to the transmission unit as the compensation capacitor for impedance matching, and the load capacitor CI can be added to the reception unit. The compensation capacitors Cs and CI may be connected in series or in parallel to the receiving coil Ls and the load coil LI, respectively. Further, for the impedance matching, a passive element such as an additional capacitor and an inductor may be added to each of the transmitter and the receiver as well as the compensation capacitor.

FIG. 2 is a self-resonant-type equivalent circuit.

Referring to FIG. 2, in the self-resonant-type equivalent circuit, a transmitter includes a source coil constituting a closed circuit by a series connection of a source voltage Vs, a source resistor Rs and a source inductor Ls, and a transmitting-side resonant coil constituting a closed circuit by a series connection of the transmission-side resonance inductor L1 and the transmission-side resonance capacitor C1. A receiver include a load coil constituting a closed circuit by a series connection of the load resistance RI and the load inductor LI, and a receiving-side resonance coil constituting a closed circuit by a series connection of a receiving side resonance inductor L2 and a resonance capacitor C2. The source inductor Ls and the transmission-side resonance inductor L1 are magnetically coupled to each other by the coupling coefficient of K01, and the load inductor LI, the receiving side resonance inductor L2 are magnetically coupled to each other by the coupling coefficient of K23, and the transmission-side resonance inductor L1 and the receiving side resonance inductor L2 are magnetically coupled to each other by the coupling coefficient of K12. In the equivalent circuit of another embodiment, the source coil and/or the load coil may be omitted and only the transmission-side resonance coil and the reception-side resonance coil may be disposed.

When the resonance frequencies of the two resonators are the same, most of the energy of the resonator of the transmitting part is transmitted to the resonator of the receiving part to improve the power transmission efficiency, and when the efficiency in the self-resonance method satisfies the following equation 2, it gets better.

k/Γ>>1 (k is the coupling coefficient, Γ attenuation factor) Equation 2

In order to increase the efficiency in the self-resonance method, an element for impedance matching can be added, and the impedance matching element can be a passive element such as an inductor and a capacitor.

Based on the principle of wireless power transmission, a wireless power transmission system for transmitting power by a magnetic induction method or a self-resonance method will be described.

<Transmitter>

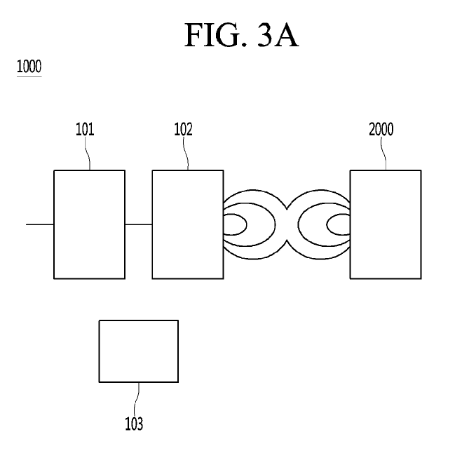

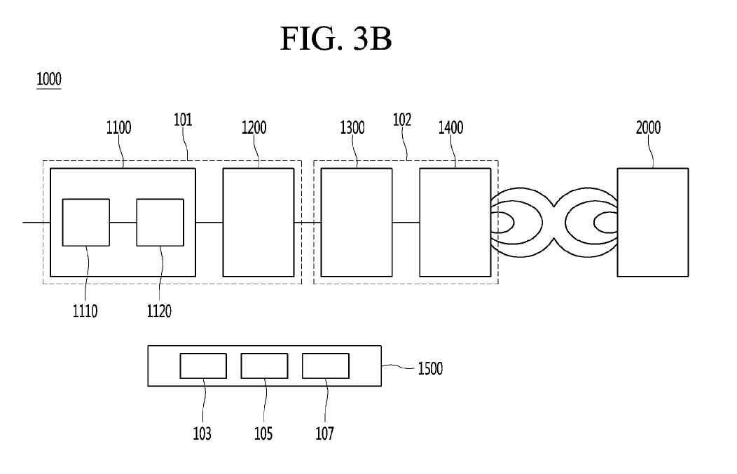

FIGS. 3A and 3B are block diagrams showing a transmitter as one of sub-systems constituting a wireless power transmission system.

Referring to FIG. 3A, the wireless power transmission system according to the embodiment may include a transmitter 1000 and a receiver 2000 that receives power wirelessly from the transmitter 1000. The transmission unit 1000 includes a power conversion unit 101 for converting an input AC signal into an AC signal and outputting the AC signal as an AC signal, a resonance circuit unit 102 for generating a magnetic field based on the AC signal output from the power conversion unit 101 and providing a power to the receiver 2000 in a charging area, and a control unit 103 for controlling a power conversion of the power conversion unit 101, adjusting the amplitude and frequency of the power conversion unit 101, performing an impedance matching of the resonance circuit unit 102, sensing impedance, voltage and current information from the resonance circuit unit 102, and wirelessly communicating with the reception unit 2000. The power conversion unit 101 may include at least one of a power conversion unit that converts an AC signal to DC, a power conversion unit that outputs a DC by varying the level of the DC, and a power conversion unit that converts DC into AC. The resonant circuit unit 102 may include a coil and an impedance matching unit capable of resonating with the coil. The control unit 103 may include a sensing unit and a wireless communication unit for sensing impedance, voltage, and current information.

Referring to FIG. 3b, the transmitting unit 1000 includes a transmitting side AC/DC converting unit 1100, a transmitting side DC/AC converting unit 1200, a transmitting side impedance matching unit 1300, a transmitting coil unit 1400, and a transmission side communication and control unit 1500.

The transmitting side AC/DC converting unit 1100 is a power converting unit that converts an AC signal provided from the outside under the control of the transmitting side communication and control unit 1500 to a DC signal. The transmitting side AC/DC converting unit 1100 includes a rectifier 1110 and a transmission side DC/DC converter 1120 as a subsystem. The rectifier 1110 converts a AC signal into a DC signal. The rectifier 1110 may be a diode rectifier having a relatively high efficiency in high frequency operation, a synchronous rectifier capable of one-chip operation, and a hybrid rectifier capable of saving space and having a high degree of freedom in dead time. However, the invention is not limited to this, and can be applied to a system for converting AC to DC. In addition, the transmission side DC/DC converter 1120 controls the level of the DC signal provided from the rectifier 1110 under the control of the transmission side communication and control unit 1500. As an example of implementing the DC signal, a buck converter, a boost converter that boosts the level of the input signal, a buck-boost converter or a Cuk converter that can raise or lower the level of the input signal can be used. Also, the transmission side DC/DC converter 1120 includes a switching element that performs a power conversion control function, an inductor and a capacitor that perform a power conversion mediation role or an output voltage smoothing function, and a transformer that performs a voltage gain control function or an electrical separation function (insulation function). The transmission side DC/DC converter 1120 performs removing the ripple component or the ripple component (AC component included in the DC signal) included in the input DC signal. The error between the command value of the output signal of the transmission side DC/DC converter 1120 and the actual output value can be adjusted through the feedback method, and this can be performed by the transmission side communication and control unit 1500.

The transmission side DC/AC conversion unit 1200 is a system that converts a DC signal output from the transmission side AC/DC conversion unit 1100 into an AC signal under the control of the transmission side communication and control unit 1500 and outputs the converted AC signal frequency. A half bridge inverter or a full bridge inverter is an example of implementing this system. In the wireless power transmission system, various amplifiers for converting direct current to alternating current can be applied. For example, there are class A, class B, class AB, class C, class E class F amplifiers. The transmission side DC/AC conversion unit 1200 may include an oscillator for generating a frequency of an output signal and a power amplifier for amplifying an output signal.

The transmission-side impedance matching unit 1300 minimizes the reflected waves at points having different impedances to improve the signal flow. Since the two coils of the transmitting unit 1000 and the receiving unit 2000 are spatially separated and leakage of the magnetic field is large, the impedance difference between the two connecting ends of the transmitting unit 1000 and the receiving unit 2000 is corrected such that power transfer efficiency improves. The impedance matching unit 1300 may include an inductor, a capacitor, and a resistance element. The impedance of the inductor, the capacitance of the inductor, and the resistance of the resistance may be varied under the control of the communication and control unit 1500 such that the impedance value can be adjusted. When the wireless power transmission system transmits power in a self-induction manner, the transmission-side impedance matching unit 1300 may have a series resonance structure or a parallel resonance structure, and may increase an inductive coupling coefficient between the transmission unit 1000 and the reception unit 2000 such that the energy loss can be minimized by increasing the inductive coupling coefficient. When the wireless power transmission system transmits power in a self-resonant manner, the transmission-side impedance matching unit 1300 may change the separation distance between the transmission unit 1000 and the reception unit 2000, or may perform real-time correction of impedance matching according to a change in matching impedance on an energy transmission line due to a change in characteristics of a coil due to mutual influence by a foreign object (FO) or a plurality of devices. A matching method, a method using a multi-loop, or the like can be used as a correction method.

The transmission coil 1400 may be implemented as a plurality of coils or a single coil. If a plurality of transmission coils 1400 are provided, they may be spaced apart from each other or be overlapped with each other. The overlapping area between the plurality of transmission coils 1400 can be determined in consideration of the deviation of the magnetic flux density. Also, when fabricating the transmission side coil 1400, it can be manufactured in consideration of the internal resistance and the radiation resistance. If the resistance component is small, the quality factor can be increased and the transmission efficiency can be increased.

The communication and control unit 1500 may include a transmission side control unit 1510 and a transmission side communication unit 1520. The transmission-side controller 1510 may adjust the output voltage of the transmission-side AC/DC converter 1100 in consideration of the power demand of the receiver 2000, the current charge amount, and the wireless power scheme. The frequency and switching waveforms for driving the transmission side DC/AC converter 1200 may be generated in consideration of the maximum power transmission efficiency to control power to be transmitted. Also, the overall operation of the receiving unit 2000 can be controlled using an algorithm, a program, or an application required for the control read from the storage unit (not shown) of the receiving unit 2000. Meanwhile, the transmission-side controller 1510 may be referred to as a microprocessor, a microcontroller unit, or a microcomputer. The transmission-side communication unit 1520 can perform communication with the reception-side communication unit 2620, and can use a short-range communication scheme such as Bluetooth, NFC, Zigbee, etc. as a communication scheme. The transmission side communication unit 1520 and the reception side communication unit 2620 can transmit and receive the charging status information and the charging control command to each other. The charging status information may include the number of the receiving unit 2000, the remaining battery level, the number of times of charging, the amount of usage, the battery capacity, the battery ratio, and the transmission power amount of the transmission unit 1000. The transmission side communication unit 1520 can also transmit a charging function control signal for controlling the charging function of the receiving unit 2000 and the charging function control signal is a control signal that controls the receiving unit 2000 to enable or disable the charging function.

As described above, the transmission-side communication unit 1520 may be communicated in an out-of-band format including a separate module, but the invention is not limited thereto. The transmission-side communication unit 1520 may perform communication in an in-band format using a feedback signal to be transmitted to a transmitter. For example, the receiving unit may modulate the feedback signal and transmit information such as start of charge, end of charge, battery condition, etc. to the transmitter through a feedback signal. The transmission side communication unit 1520 may be configured separately from the transmission side control unit 1510 and the reception side communication unit 2620 and may be included in the control unit 2610 of the reception device or may be separately configured have.

The transmitting unit 1000 of the wireless power transmission system according to the embodiment may further include a detecting unit 107.

The detecting unit 107 detects at least one signal of an input signal of the transmitting side AC/DC converting unit 1100, an output signal of the transmitting side AC/DC converting unit 1100, an input signal of the transmitting side DC/AC converting unit 1200, the input signal of the transmission side impedance matching unit 1300, the output signal of the transmission side impedance matching unit 1300, the input signal of the transmission side coil 1400, or a signal on the transmission side coil 1400. The detected signal is fed back to the communication and control unit 1500 and the communication and control unit 1500 controls the transmission side AC/DC conversion unit 1100, the transmission side DC/AC conversion unit 1200, and the transmission side impedance matching unit 1300. The communication and control unit 1500 can perform FOD (Foreign Object Detection) based on the detection result of the detection unit 1600. The detected signal may be at least one of a voltage and a current. On the other hand, the detection unit 107 may be configured by hardware different from the communication and control unit 1500, or may be implemented by one hardware.

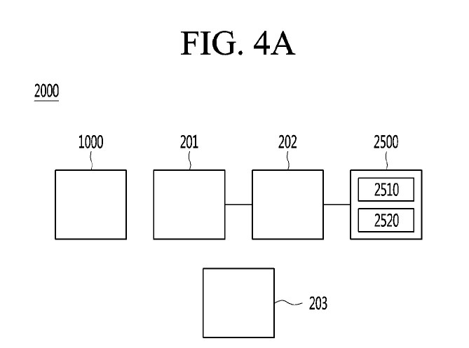

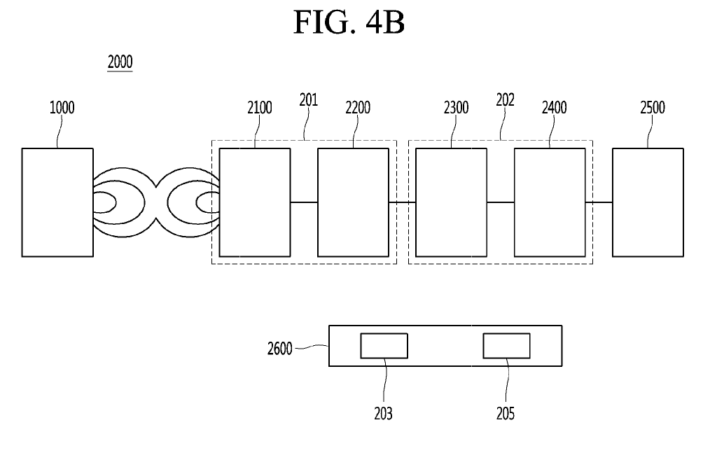

FIGS. 4a and 4b are block diagrams illustrating a wireless power receiving apparatus as one of subsystems constituting a wireless power transmission system.

According to an embodiment, the wireless power receiving apparatus 2000 may be referred to as a wireless power receiver or a receiving apparatus or receiver.

Referring to FIG. 4A, a wireless power transmission system according to an embodiment may include a transmitting apparatus 1000 and a receiving apparatus 2000 receiving power wirelessly from the transmitting apparatus 1000. The receiving apparatus 2000 includes a receiving-side resonant circuit section 201 for receiving an AC signal transmitted from the transmitting apparatus 1000, a receiving side power converting unit 202 for converting AC power from the receiving-side resonant circuit section 201 into a DC signal, a load 2500 to be charged by receiving the DC signal outputted from the converting unit 202 and a control unit 203 for sensing the DC power of the receiving-side resonant circuit section 201, performing an impedance matching of the receiving-side resonant circuit section 201, controlling a power conversion of the receiving side power converting unit 202, adjusting the level of the output signal of the receiving-side power converting section 202, sensing the output voltage or current, control whether the output signal of the reception-side power conversion unit 202 is supplied to the load 2500, or communicate with the transmission device 1000 can do. The receiving-side power converting section 202 may include a power converting section for converting the AC signal to DC, a power converting section for varying the level of the DC to output the DC, and a power converting section for converting the DC to AC.

Referring to FIG. 4B, the wireless power transmission system may include a transmitting unit 1000 and a receiving unit 2000 receiving radio power from the transmitting unit 1000. The receiving unit 2000 includes a receiving coil unit 2100, a receiving side impedance matching unit 2200, a receiving side AC/DC converting unit 2300, a DC/DC converting unit 2400, a load 2500, and a receiving side communication and control unit 2600.

The receiving side coil part 2100 can receive power through a magnetic induction type or a self-resonance type. As described above, at least one of the induction coil and the resonance coil may be included according to the power reception scheme. The receiving side coil part 2100 may include an NFC (Near Field Communication). The receiving side coil part 2100 may be the same as the transmitting side coil part 1400 and the dimension of the receiving antenna may be changed according to the electrical characteristics of the receiving part 200.

The receiving-side impedance matching unit 2200 performs impedance matching between the transmitter 1000 and the receiver 2000.

The receiving-side AC/DC converter 2300 rectifies an AC signal output from the receiving-side coil part 2100 to generate a DC signal.

The receiving-side DC/DC converting section 2400 can adjust the level of the DC signal output from the receiving-side AC/DC converting section 2300 to the capacity of the load 2500.

The load 2500 may include a battery, a display, a sound output circuit, a main processor, and various sensors.

The receiving side communication and control unit 2600 can be activated by the wake-up power from the transmitting side communication and control unit 1500, performs communication with the transmitting side communication and control unit 1500, and controls the operation of the subsystem of the receiver 2000.

The receiving unit 2000 includes a single or a plurality of receiving units 2000, and wirelessly receives energy from the transmitting unit 1000 at the same time. That is, in the self-resonant wireless power transmission system, a plurality of target receiving units 2000 can receive power from one transmitter 1000. At this time, the transmitter matching unit 1300 of the transmitter 1000 may adaptively perform impedance matching between the plurality of receiving units 2000. This can be equally applied to a case in which a plurality of reception side coil independent of each other in the magnetic induction method are provided.

When the receiving unit 2000 includes a plurality of units, the power receiving systems may be the same system or different systems. In this case, the transmitting unit 1000 may be a system for transmitting power by a magnetic induction system or a self-resonance system, or a system for mixing both systems.

Meanwhile, in the case of the wireless power transmission of the magnetic induction type, the transmission side AC/DC conversion unit 1100 in the transmission unit 1000 may transmit DC signal of several tens or several hundreds volts (for example, 10 V to 20 V) by applying an AC signal of several tens to several hundreds of Hz (for example, 60 Hz) of several tens or several hundreds volts (For example, 110 V to 220 V). The transmitting side DC/AC converting unit 1200 can receive the DC signal and output an AC signal of KHz band (e.g., 125 KHz). The receiving AC/DC converting unit 2300 of the receiving unit 2000 receives AC signals of KHz band (for example, 125 KHz) and outputs DC signals of several volts to several tens volts, several hundred volts (for example, 10V to 20V). The receiving side DC/DC converting section 2400 can output a DC signal of, for example, 5V suitable for the load 2500 and transmit it to the load 2500. In the case of the wireless power transmission of the self-resonance type, the transmitting side AC/DC converting unit 1100 in the transmitting unit 1000 may transmit DC signal of several tens or several hundreds V (for example, 10 V to 20 V) by applying an AC signal of several tens to several hundreds of Hz (for example, 60 Hz) of several tens or several hundreds volts (For example, 110 V to 220 V). The transmission side DC/AC conversion unit 1200 converts the DC signal into a DC signal of several volts to several tens volts and several hundred volts (for example, 10V to 20V), and can output an AC signal of MHz band (for example, 6.78 MHz). The receiving AC/DC converting unit 2300 of the receiving unit 2000 receives the AC signal of MHz (for example, 6.78 MHz) and receives the AC signal of several V to several tens volts, several hundred volts (for example, 10V to 20V). The DC/DC converter 2400 can output a DC signal of, for example, 5V suitable for the load 2500 and transmit it to the load 2500.

<Operational State of Transmitting Section>

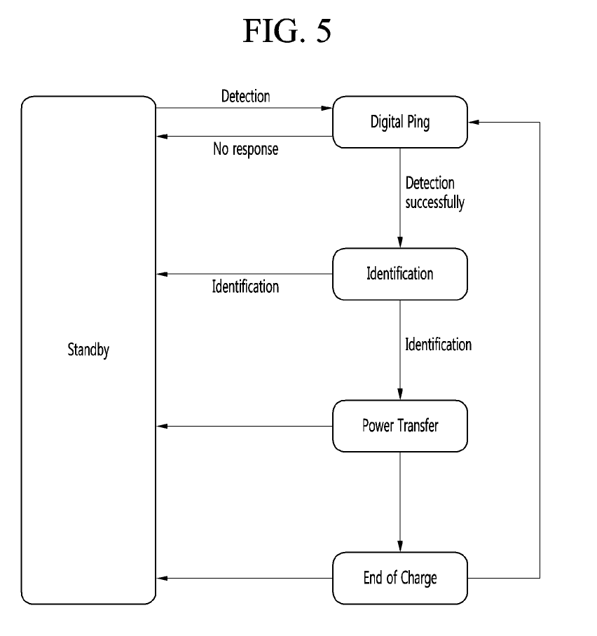

FIG. 5 is a flowchart illustrating an operation of the wireless power transmission system, and is a flowchart illustrating an operation of the wireless power transmission system.

Referring to FIG. 5, a transmitter according to an embodiment may have at least 1) a standby state, 2) a digital ping state, 3) an authentication state, 4) a power transmission state, and 5) a charge completion state.

[Standby]

(1) When power is supplied from the outside to the transmitter 1000 to start the transmitter 1000, the transmitter 1000 may be in a standby state. The transmitting unit 1000 in the standby state can detect the presence of an object (for example, the receiving unit 2000 or metallic foreign matter FO) disposed in the charging area. In addition, the transmitter 1000 can detect whether or not the object is removed from the charging area.

(2) As a method for detecting the presence of an object in the charging area, the transmitter 1000 can detect an object by monitoring a change in magnetic flux, a change in capacitance or inductance between the object and the transmitter 1000, or a shift in resonance frequency But is not limited thereto.

(3) When the transmitter 1000 detects an object that is the receiver 2000 in the charging area, it can proceed to the next digital ping state.

(4) Also, the transmitter 1000 can detect a FO such as a metallic foreign substance in the charged region when the FO is disposed within the charged region.

(5) On the other hand, if the transmitter 1000 does not acquire enough information to distinguish between the receiver 2000 and the FO in the waiting state, the receiver goes to the digital ping state or goes to the authentication state to check whether the receiver 2000 or FO have.

[Digital Ping]

(1) In the digital ping state, the transmission unit 1000 is connected to the chargeable reception unit 2000, and confirms that it is an effective reception unit 2000 that can be charged with radio power provided from the transmission unit 1000. The transmission unit 1000 can generate and output a digital ping having a predetermined frequency and timing to be connected to the chargeable reception unit 2000.

(2) If a sufficient power signal for digital ping is transmitted to the receiving unit 2000, the receiving unit 2000 can respond to the digital ping by modulating the power signal according to a communication protocol. If the transmitting unit 1000 receives a valid signal from the receiving unit 2000, it can proceed to the authentication state without removing the power signal. If the EOC (End Of Charging) request is received from the receiving unit 2000, the transmitting unit 1000 may proceed to the charging end state.

(3) In addition, when the effective receiving unit 2000 is not detected or when the response time of the object for the digital ping exceeds a predetermined time, the transmitting unit 1000 can return to the standby state by removing the power signal. Therefore, if the FO is placed in the charging area, the transmitter 1000 can return to the standby state because the FO cannot make any response.

[Identification]

(1) When the response of the receiving unit 2000 according to the digital ping of the transmitting unit 1000 is completed, the transmitting unit 1000 may transmit the transmitting unit authentication information to the receiving unit 2000 to confirm compatibility between the transmitting and receiving units 1000 and 2000. When the compatibility is confirmed, the receiving unit 2000 can transmit authentication information to the transmitting unit 1000. The transmitting unit 1000 can confirm the receiving unit authentication information of the receiving unit 2000.

(2) When the mutual authentication is completed, the transmitter 1000 proceeds to the power transmission state. If the authentication fails, or the authentication time exceeds the predetermined authentication time, the transmitter 1000 can return to the standby state.

[Power Transfer State]

(1) The communication and control unit 1500 of the transmission unit 1000 can provide charging power to the reception unit 2000 by controlling the transmission unit 1000 based on the control data provided from the reception unit 2000.

(2) Furthermore, the transmitter 1000 can verify that the proper operating range is not exceeded or that the stability according to the FOD is not problematic.

(3) In addition, when the transmitter 1000 receives a charge completion signal from the receiver 2000, or if the transmitter 1000 receives a predetermined limit temperature value, the transmitter 1000 can stop the power transmission and proceed to the charge completion state.

(4) In addition, when the situation becomes unsuitable for transmitting power, the power signal can be removed and returned to the standby state. If the receiving unit 2000 enters the charging area again after the receiving unit 2000 is removed, the above-described cycle can be performed again.

(5) In accordance with the charged state of the load 2500 of the receiving unit 2000, the charged state can be returned to the authenticated state again and the adjusted charging power can be provided to the receiving unit 2000 based on the state information of the load 2500.

[End of Charge (EOC))

(1) The transmitter 1000 may receive information indicating that charging has been completed from the receiver 2000 or may proceed to a charging termination state when the receiver 2000 receives information that the receiver 2000 has risen above a preset temperature.

(2) When the transmitting unit 1000 receives the charging completion information from the receiving unit 2000, the transmitting unit can stop the power transmission and wait for a predetermined time. After a predetermined time has elapsed, the transmitting unit 1000 may enter the digital ping state to be connected to the receiving unit 2000 disposed in the charging area.

(3) If the transmitter 1000 receives information indicating that the preset temperature has been exceeded from the receiver 2000, it can wait for a certain period of time. After a lapse of a predetermined time, the transmitting unit 1000 may enter the digital ping state to be connected to the receiving unit 2000 disposed in the charging area.

(4) Also, the transmitter 1000 can monitor whether the receiver 2000 is removed from the charging area for a predetermined time, and can return to the standby state when the receiver 2000 is removed from the charging area.

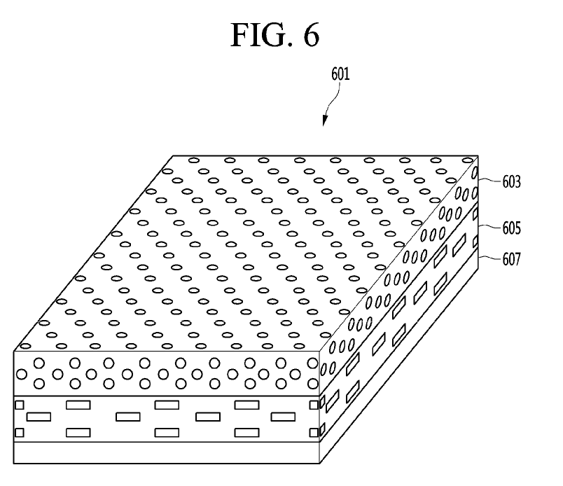

FIG. 6 shows a shielding member according to an embodiment.

The wireless power transmitter according to an embodiment may include a control circuit, at least one transmission coil, and a shielding member 601. For example, the shielding member 601 may be disposed between the transmission coil and the control circuit. The shielding member 601 according to the embodiment may be a single sheet in which the heat release sheet 603 and the shielding sheet 605 are combined. The heat release sheet 603 may be a silicone polymer containing ceramic powder.

The shielding sheet 605 may be a rubber including a magnetic metal powder. The shielding member 601 may be bonded to the control circuit and/or the transmission coil through the adhesive 601.

A wireless power receiver according to an embodiment may include a control circuit, at least one receiving coil, and a shielding member 601. For example, the shielding member 601 may be disposed between the receiving coil and the control circuit. The shielding member 601 according to the embodiment may be a single sheet in which the heat release sheet 603 and the shielding sheet 605 are combined. The heat release sheet 603 may be a silicone polymer including a ceramic powder.

The shielding sheet 605 may be a rubber including a magnetic metal powder. The shielding member 601 may be bonded to the control circuit and or the receiving coil through an adhesive 607. Although FIG. 6 shows the adhesive 607 disposed at the lower end of the shield 601, the adhesive 607 may be disposed at the top of the shielding 601, according to various embodiments.

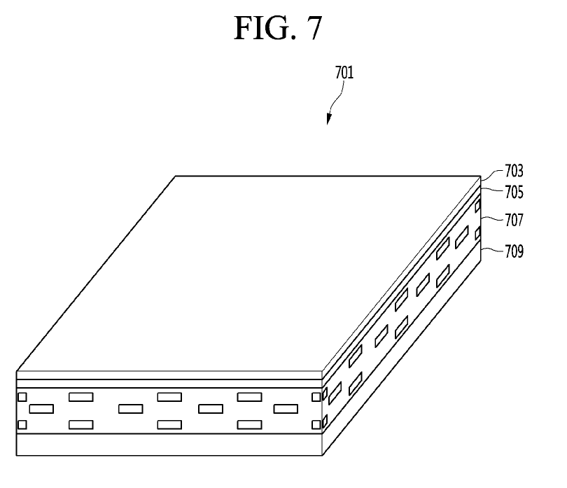

FIG. 7 shows a shielding member according to another embodiment.

A wireless power transmitter in accordance with another embodiment may include a control circuit, at least one transmission coil, and a shielding member 701. For example, the shielding member 701 may be disposed between the transmission coil and the control circuit. The shielding member 701 according to another embodiment may be a single sheet in which the heat release sheets 703 and 705 and the shielding sheet 707 are combined.

The heat release sheet according to another embodiment may include a protective sheet 703 and a metal sheet 705. The metal sheet 705 may be disposed on the upper portion of the shielding sheet 707. The protective sheet 703 may be disposed on the upper portion of the metal sheet 705.

The shielding sheet 707 may be a rubber containing a magnetic metal powder. The shielding member 701 may be bonded to the control circuit and/or the transmission coil through an adhesive 709.

The wireless power receiver according to another embodiment may include a control circuit, at least one receiving coil, and a shielding member 701. For example, the shielding member 701 may be disposed between the receiving coil and the control circuit. The shielding member 701 according to the embodiment may be a single sheet in which the heat release sheets 703 and 705 and the shielding sheet 707 are combined.

The heat release sheet according to another embodiment may include a protective sheet 703 and a metal sheet 705. The metal sheet 705 may be disposed on the upper portion of the shielding sheet 707. The protective sheet 703 may be disposed on the upper portion of the metal sheet 705.

The shielding sheet 707 may be a rubber containing a magnetic metal powder. The shielding member 701 may be bonded to the control circuit or the receiving coil through an adhesive 709. FIG. 7 shows that the adhesive 709 is disposed at the lower end of the shielding member 701, the adhesive 709 may be disposed at the top of the shielding member 701 according to various embodiments.

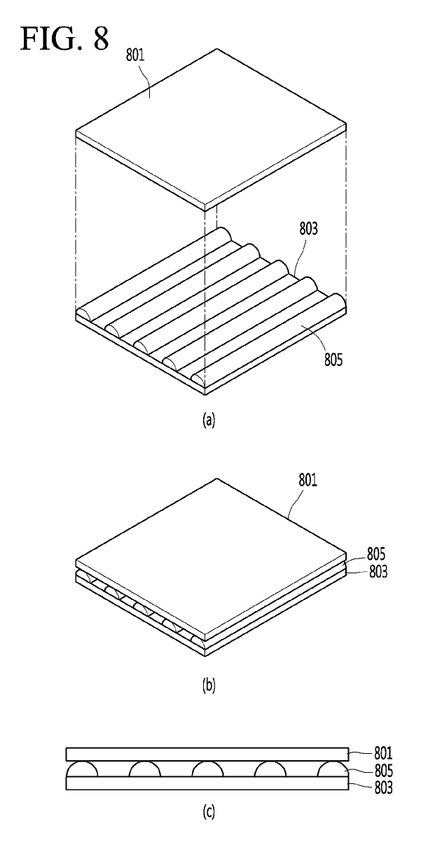

FIG. 8 shows a control circuit and a shielding member included in a wireless power transmitter or a wireless power receiver according to another embodiment.

Referring to FIG. 8A, a wireless power transmitter or a wireless power receiver according to another embodiment may include a control circuit 801 and a shielding member. Further, the shielding member may include a shielding sheet 803. The shielding sheet 803 according to another embodiment may include a plurality of protruding patterns 805. The shielding sheet 803 can expand the surface area through the plurality of protruding patterns 805 to increase the heat releasing efficiency. The shielding sheet 803 may include a plurality of protruding patterns 805 on the upper surface facing the control circuit 801.

Referring to FIG. 8B, the shielding sheet 803 may be spaced apart from the control circuit 801 by a plurality of protruding patterns 805. Referring to FIG. 8C, air may be introduced through the spaced gaps or spaces of the shielding sheet 803. The release effect of the shielding sheet 803 may be increased due to the air. The height of the plurality of protruding patterns 805 may be less than ½ of the height of the shielding sheet 803. The area of the plurality of protruding patterns 805 may be less than half the area of the shielding sheet 803.

The plurality of protruding patterns 805 may not be separated from the shielding sheet 803, but may be formed integrally with each other in injection. That is, the shielding sheet 803 may be manufactured in a form including a plurality of protruding patterns 805.

The number of the plurality of protruding patterns 805 may be 10 or less. In accordance with various embodiments, the number of protruding patterns 805 may exceed ten.

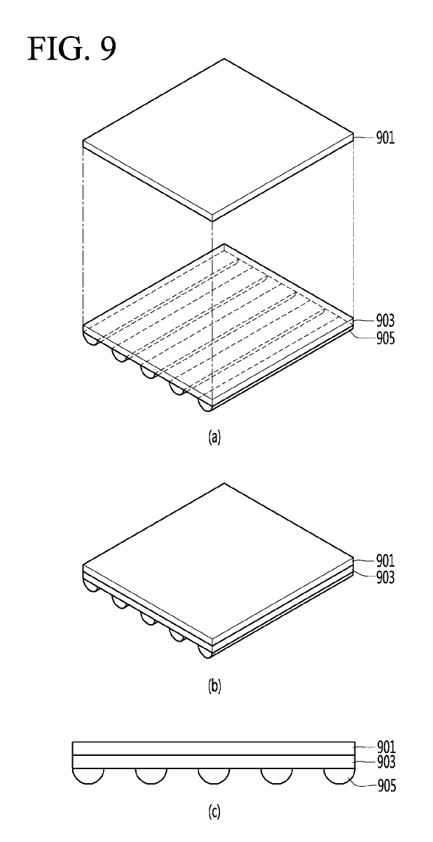

FIG. 9 shows a control circuit and a shielding member included in a wireless power transmitter or a wireless power receiver according to another embodiment.

Referring to FIG. 9A, a wireless power transmitter or a wireless power receiver according to another embodiment may include a control circuit 901 and a shielding member. Further, the shielding member may include a shielding sheet 903. The shielding sheet 903 according to another embodiment may include a plurality of protruding patterns 905. The shielding sheet 903 can expand the surface area through a plurality of protruding patterns 905 to increase the heat generation efficiency. Referring to FIGS. 9B and 9C, the shielding sheet 903 may include a plurality of protruding patterns 905 on the bottom surface not facing the control circuit 901. The height of the plurality of protruding patterns 905 may be less than ½ of the height of the shielding sheet 903. The area of the plurality of protruding patterns 905 may be less than half the area of the shielding sheet 903.

The plurality of protruding patterns 905 may not be separated from the shielding sheet 903, but may be formed integrally with each other at the time of injection. That is, the shielding sheet 903 may be manufactured in a form including a plurality of protruding patterns 905.

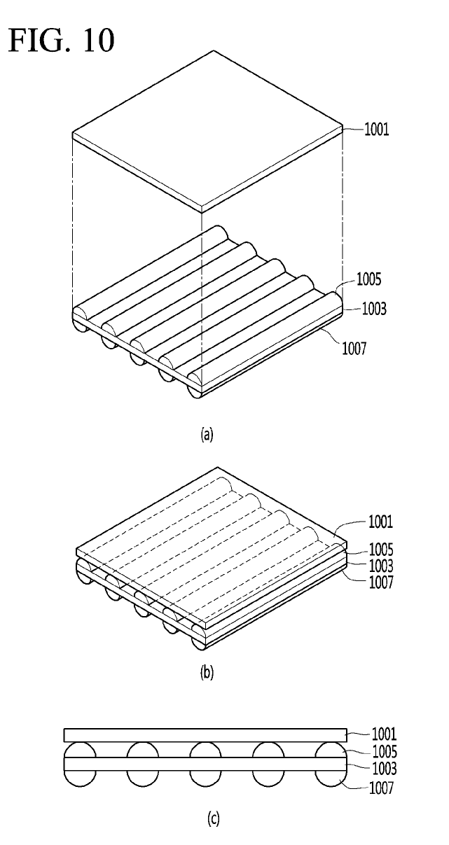

FIG. 10 shows a control circuit and a shielding member included in a wireless power transmitter or a wireless power receiver according to another embodiment.

Referring to FIG. 10A, a wireless power transmitter or a wireless power receiver according to another embodiment of may include a control circuit 1001 and a shielding member. Further, the shielding member may include a shielding sheet 1003. The shielding sheet 1003 according to another embodiment may include a plurality of protruding patterns 1005 on the upper surface. In addition, the shielding sheet 1003 may include a plurality of protruding patterns 1007 on the bottom surface. The shielding sheet 1003 can increase the heat releasing efficiency by enlarging the surface area through the plurality of protruding patterns 1005 and 1007 disposed on the upper and lower surfaces.

Referring to FIG. 10B, the shielding sheet 1003 may be disposed with a gap or space spaced apart from the control circuit 1001 due to a plurality of protruding patterns 1005 on the upper surface. Referring to FIG. 10C, air can be introduced through the spaced gaps or spaces of the shielding sheet 1003. The releasing effect of the shielding sheet 1003 can be increased due to the air. The height of the plurality of protruding patterns 1005 and 1007 may be less than ½ of the height of the shielding sheet 1003. The area of the plurality of protruding patterns 1005 and 1007 may be less than half the area of the shielding sheet 1003.

The plurality of protruding patterns 1005 and 1007 may not be separated from the shielding sheet 1003, but may be integrally formed at the time of injection. That is, the shielding sheet 1003 may be manufactured in a form including a plurality of protruding patterns 1005.

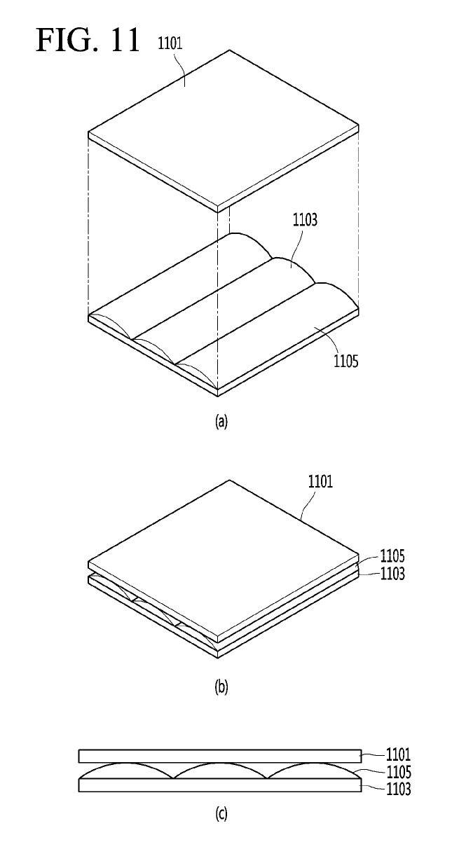

FIG. 11 shows a control circuit and a shielding member included in a wireless power transmitter or a wireless power receiver according to another embodiment.

Referring to FIG. 11A, a wireless power transmitter or a wireless power receiver according to another embodiment may include a control circuit 1101 and a shielding member. In addition, the shielding member may include a shielding sheet 1103. The shielding sheet 1103 according to another embodiment may include a plurality of protruding patterns 1105. The shielding sheet 1103 can increase the heat releasing efficiency by enlarging the surface area through the plurality of protruding patterns 1105. The shielding sheet 1103 may include a plurality of protruding patterns 1105 on the upper surface facing the control circuit 1101.

Referring to FIG. 11B, the shielding sheet 1103 may be spaced apart from the control circuit 1101 by a plurality of protruding patterns 1105. Referring to FIG. 11C, air can be introduced through the spaced gaps or spaces of the shielding sheet 1103. The releasing effect of the shielding sheet 1103 may be increased due to the air. The height of the plurality of protruding patterns 1105 may be less than ½ of the height of the shielding sheet 1103. The area of the plurality of protruding patterns 1105 may be 50% to 100% of the area of the shielding sheet 1103.

According to various embodiments, the height of the plurality of protruding patterns 1105 may exceed ½ of the height of the shielding sheet 1103. Further, the area of the plurality of protruding patterns 1105 may be less than 50% of the area of the shielding sheet 1103.

The plurality of protruding patterns 1105 may not be separated from the shielding sheet 1103, but may be integrally formed at the time of injection. That is, the shielding sheet 1103 may be manufactured in a form including a plurality of protruding patterns 1105.

The number of the plurality of protruding patterns 1105 may be 10 or less. According to various embodiments, the number of the plurality of protruding patterns 1105 may exceed ten.

In FIG. 11, the cross-section of the plurality of protruding patterns 1105 is shown as an ellipse having a convex upper surface. However, the shapes of the plurality of protruding patterns 1105 may vary according to various embodiments. For example, the cross-section of the plurality of protruding patterns 1105 may be in the form of a concave oval-shaped top surface. In addition, the cross-section of the plurality of protruding patterns 1105 may be triangular. In addition, the cross-section of the plurality of protruding patterns 1105 may have a trapezoidal shape with a narrow upper surface.

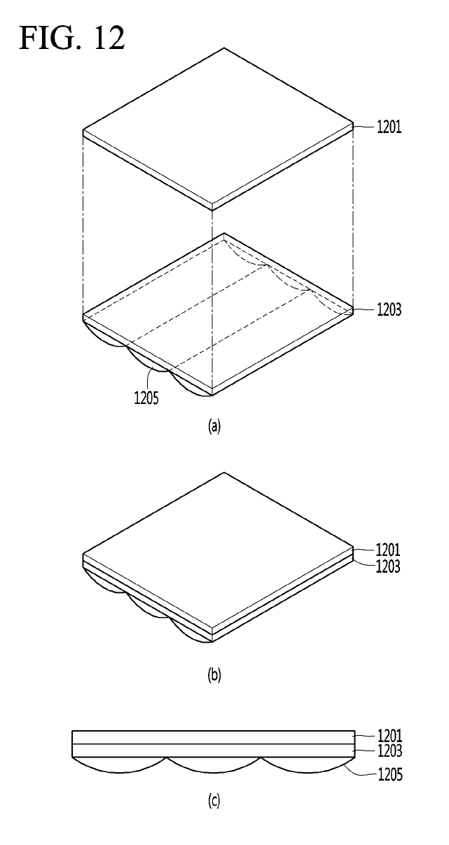

FIG. 12 shows a control circuit and a shielding member included in a wireless power transmitter or a wireless power receiver according to another embodiment.

Referring to FIG. 12A, a wireless power transmitter or a wireless power receiver according to another embodiment may include a control circuit 1201 and a shielding member. In addition, the shielding member may include a shielding sheet 1203. The shielding sheet 1203 according to another embodiment may include a plurality of protruding patterns 1205. The shielding sheet 1203 can expand the surface area through the plurality of protruding patterns 1205 to increase the heat releasing efficiency. Referring to FIGS. 12B and 12C, the shielding sheet 1203 may include a plurality of protruding patterns 1205 on a bottom surface that does not face the control circuit 1201. The height of the plurality of protruding patterns 1205 may be less than half the height of the shielding sheet 1203. The area of the plurality of protruding patterns 1205 may be 50% to 100% of the area of the shielding sheet 1203.

The number of the plurality of protruding patterns 1205 may be 10 or less. According to various embodiments, the number of protruding patterns 1205 may exceed ten.

According to various embodiments, the height of the plurality of protruding patterns 1205 may exceed ½ of the height of the shielding sheet 1203. Further, the area of the plurality of protruding patterns 1205 may be less than 50% of the area of the shielding sheet 1203.

The plurality of protruding patterns 1205 may not be separated from the shielding sheet 1203, but may be integrally formed at the time of injection. That is, the shielding sheet 1203 may be manufactured in a form including a plurality of protruding patterns 1205.

In FIG. 12, the cross-section of the plurality of protruding patterns 1205 is an elliptical shape having a convex upper surface. However, the shapes of the plurality of protruding patterns 1205 may vary according to various embodiments. For example, the cross-section of the plurality of protruding patterns 1205 may have a concave elliptical shape with a top surface. In addition, the cross-section of the plurality of protruding patterns 1205 may be triangular. In addition, the cross-section of the plurality of protruding patterns 1205 may have a trapezoidal shape with a narrow upper surface.

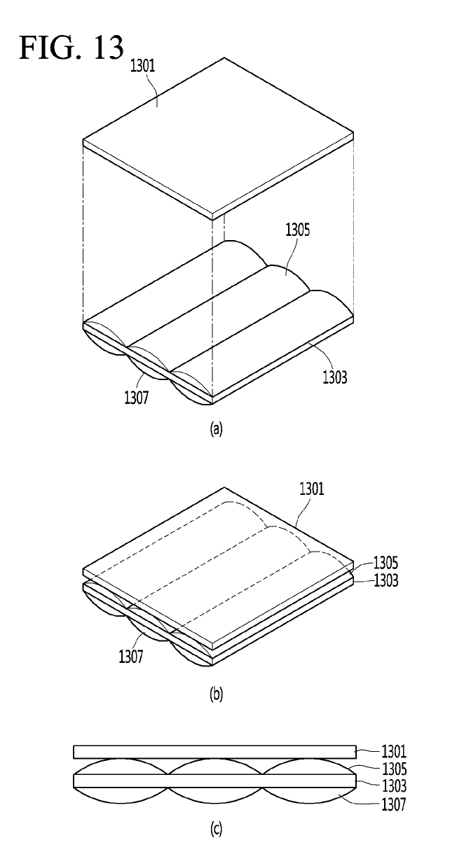

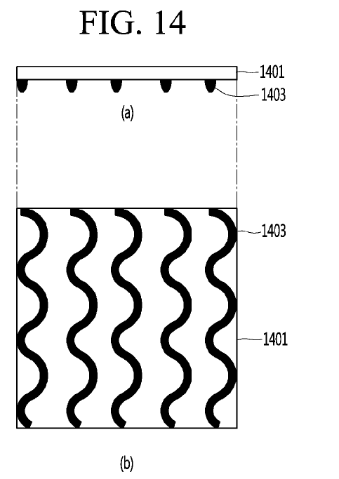

FIG. 13 shows a control circuit and a shielding member included in a wireless power transmitter or a wireless power receiver according to another embodiment.

Referring to FIG. 13A, a wireless power transmitter or a wireless power receiver according to another embodiment may include a control circuit 1301 and a shielding member. In addition, the shielding member may include a shielding sheet 1303. The shielding sheet 1303 according to another embodiment may include a plurality of protruding patterns 1305 on the upper surface. In addition, the shielding sheet 1303 may include a plurality of protruding patterns 1307 on the bottom surface. The shielding sheet 1303 can increase the heat releasing efficiency by enlarging the surface area through the plurality of protruding patterns 1305 and 1307 on the upper and lower surfaces.

Referring to FIG. 13B, the shielding sheet 1303 may be spaced apart from the control circuit 1301 by a plurality of protruding patterns 1305 on the upper surface. Referring to FIG. 13C, air can be introduced through the spaced gap or space of the shielding sheet 1303. The releasing effect of the shielding sheet 1303 may be increased due to the air. The height of the plurality of protruding patterns 1305 and 1307 may be less than ½ of the height of the shielding sheet 1303. The area of the plurality of protruding patterns 1305 and 1307 may be 50% to 100% of the area of the shielding sheet 1303.

The number of the plurality of protruding patterns 1305 and 1307 may be 10 or less. According to various embodiments, the number of the plurality of protruding patterns 1305, 1307 may exceed ten.

According to various embodiments, the height of the plurality of protruded patterns 1305, 1307 may exceed one-half the height of the shielding sheet 1303. Further, the area of the plurality of protruding patterns 1305 and 1307 may be less than 50% of the area of the shielding sheet 1303.

The plurality of protruding patterns 1305 and 1307 may be formed integrally with the shielding sheet 1303 instead of being separated from the shielding sheet 1303. That is, the shielding sheet 1303 may be manufactured in a form including a plurality of protruding patterns 1305.

In FIG. 13, the cross-section of the plurality of protruding patterns 1305 and 1307 is an elliptical shape having a convex upper surface. However, the shape of the plurality of protruding patterns 1305 and 1307 may vary according to various embodiments. For example, the cross-section of the plurality of protruding patterns 1305 and 1307 may be a concave oval-shaped top surface. In addition, the cross-section of the plurality of protruding patterns 1305 and 1307 may be triangular. In addition, the cross-section of the plurality of protruding patterns 1305 and 1307 may have a trapezoidal shape with a narrow upper surface.

FIG. 14 shows a pattern of a shielding member included in a wireless power transmitter or a wireless power receiver according to an embodiment.

FIG. 14A is a side view of a shielding sheet 1401 including a plurality of protruded patterns 1403 according to an embodiment. FIG. 14B is a top view of a shielding sheet 1401 including a plurality of protruded patterns 1403 according to an embodiment.

Referring to FIGS. 14A and 14B, the shielding sheet 1401 may include a plurality of protruding patterns 1403 having a wavy shape. The shielding sheet 1401 can increase the heat releasing efficiency by extending the surface area through a plurality of protruding patterns 1403 having a wavy shape.

The height of the plurality of protruding patterns 1403 may be less than ½ of the height of the shielding sheet 1401. The area of the plurality of protruding patterns 1403 may be less than half the area of the shielding sheet 1401.

FIG. 14 shows that a plurality of protruding patterns 1403 are located on one side of the shielding sheet 1401. However, according to various embodiments, the plurality of protruding patterns 1403 are disposed on both surfaces of the shielding sheet 1401.

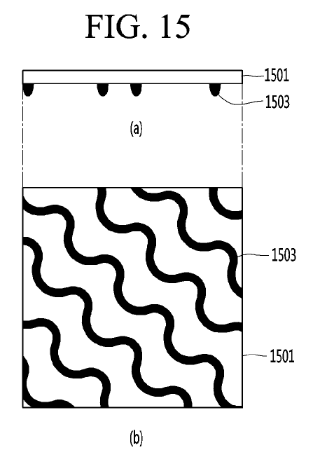

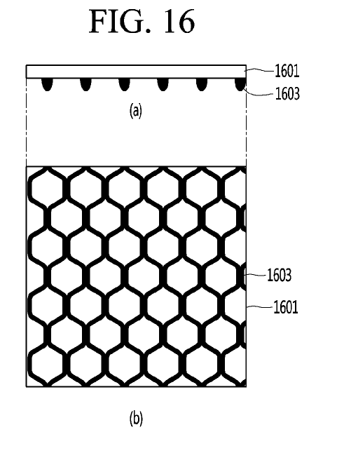

FIG. 15 shows a pattern of a shielding member included in a wireless power transmitter or a wireless power receiver according to another embodiment.

FIG. 15A is a side view of a shielding sheet 1501 including a plurality of protruding patterns 1503 according to another embodiment. FIG. 15B is a top view of a shielding sheet 1501 including a plurality of protruding patterns 1503 according to another embodiment.

Referring to FIGS. 15A and 15B, the shielding sheet 1501 may include a plurality of protruding patterns 1503 having a wavy line shape. The shielding sheet 1501 can increase the heat releasing efficiency by enlarging the surface area through a plurality of protruding patterns 1503 in the form of wavy lines.

The height of the plurality of protruding patterns 1503 may be less than ½ of the height of the shielding sheet 1501. The area of the plurality of protruding patterns 1503 may be less than half the area of the shielding sheet 1501.

FIG. 15 shows that a plurality of protruding patterns 1503 are located on one side of the shielding sheet 1501, but according to various embodiments, the plurality of protruding patterns 1503 are disposed on both surfaces of the shielding sheet 1501.

FIG. 16 illustrates a pattern of a shielding member included in a wireless power transmitter or a wireless power receiver according to another embodiment.

FIG. 16A is a side view of a shielding sheet 1601 including a plurality of protruding patterns 1603 according to another embodiment. FIG. 16B is a top view of a shielding sheet 1601 including a plurality of protruded patterns 1603 according to another embodiment.

Referring to FIGS. 16A and 16B, the shielding sheet 1601 may include a plurality of protruding patterns 1603 having a honeycomb shape. The shielding sheet 1601 can increase the heat releasing efficiency by enlarging the surface area through a plurality of honeycomb protruding patterns 1603.

The height of the plurality of protruding patterns 1603 may be less than ½ of the height of the shielding sheet 1601. The area of the plurality of protruding patterns 1603 may be less than half the area of the shielding sheet 1601. FIG. 16 shows that a plurality of protruding patterns 1603 are located on one side of the shielding sheet 1601. However, according to various embodiments, the plurality of protruding patterns 1603 are disposed on both surfaces of the shielding sheet 1601.

FIG. 16 shows that a plurality of protruding patterns 1603 are located on one side of the shielding sheet 1601. However, according to various embodiments, the plurality of protruding patterns 1603 are disposed on both surfaces of the shielding sheet 1601.

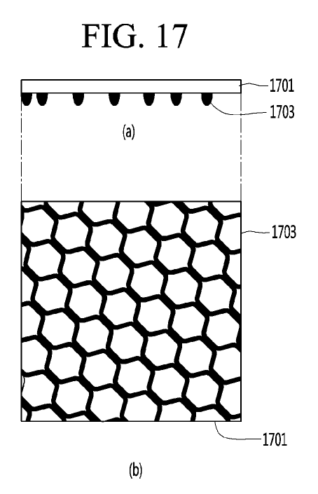

FIG. 17 illustrates a pattern of a shielding member included in a wireless power transmitter or a wireless power receiver according to another embodiment.

FIG. 17A is a side view of a shielding sheet 1701 including a plurality of protruding patterns 1703 according to another embodiment. FIG. 17B is a top view of a shielding sheet 1701 including a plurality of protruding patterns 1703 according to an embodiment.

Referring to FIGS. 17A and 17B, the shielding sheet 1701 may include a plurality of protruding patterns 1703 having a tetragonal honeycomb. The shielding sheet 1701 can increase the heat releasing efficiency by enlarging the surface area through a plurality of protruding patterns 1703 of the tetragonal honeycomb.

The height of the plurality of protruding patterns 1703 may be less than ½ of the height of the shielding sheet 1701. The area of the plurality of protruding patterns 1703 may be less than half the area of the shielding sheet 1701. FIG. 17 shows that a plurality of protruding patterns 1703 are located on one side of the shielding sheet 1701, but according to various embodiments, a plurality of protruding patterns 1703 are disposed on both surfaces of the shielding sheet 1701.

The plurality of protruding patterns 1703 may not be disposed separately from the shielding sheet 1701, but may be integrally formed at the time of injection. That is, the shielding sheet 1701 may be manufactured in a form including a plurality of protruding patterns 1703.

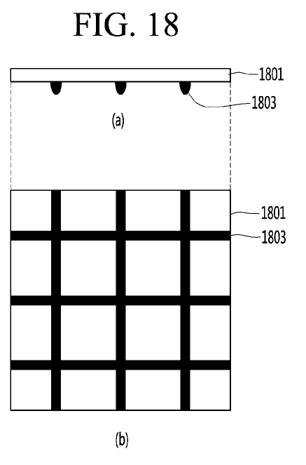

FIG. 18 shows a pattern of a shielding member included in a wireless power transmitter or a wireless power receiver according to another embodiment.

FIG. 18A is a side view of a shielding sheet 1801 including a plurality of protruded patterns 1803 according to another embodiment. FIG. 18B is a top view of a shielding sheet 1801 including a plurality of protruded patterns 1803 according to another embodiment.

Referring to FIGS. 18A and 18B, the shielding sheet 1801 may include a plurality of protruding patterns 1803 of an intersecting type. The shielding sheet 1801 can increase the heat releasing efficiency by extending the surface area through the plurality of protruding patterns 1803 of the crossing type.

The height of the plurality of protruding patterns 1803 may be less than ½ of the height of the shielding sheet 1801. The area of the plurality of protruding patterns 1803 may be less than ½ of the area of the shielding sheet 1801. FIG. 13 shows that a plurality of protruding patterns 1803 are located on one side of the shielding sheet 1801, but according to various embodiments, the plurality of protruding patterns 1803 are disposed on both surfaces of the shielding sheet 1801.

The plurality of protruded patterns 1803 may not be separated from the shielding sheet 1801, but may be integrally formed at the time of injection. That is, the shielding sheet 1801 may be manufactured in a form including a plurality of protruding patterns 1803.

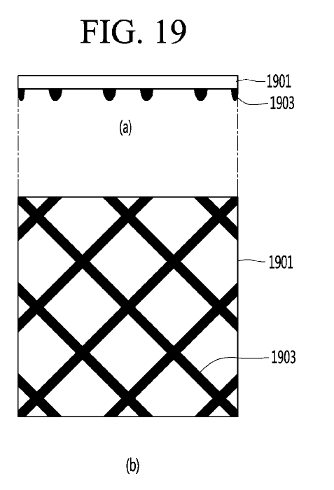

FIG. 19 shows a pattern of a shielding member included in a wireless power transmitter or a wireless power receiver according to another embodiment.

FIG. 19A is a side view of a shielding sheet 1901 including a plurality of protruding patterns 1903 according to another embodiment. FIG. 19B is a top view of a shielding sheet 1901 including a plurality of protruded patterns 1903 according to another embodiment.

Referring to FIGS. 19A and 19B, the shielding sheet 1901 may include a plurality of protruding patterns 1903 intersecting obliquely. The shielding sheet 1901 can increase the heat releasing efficiency by enlarging the surface area through a plurality of protruding patterns 1903 crossing obliquely. The height of the plurality of protruding patterns 1903 may be less than half the height of the shielding sheet 1901. The area of the plurality of protruding patterns 1903 may be less than half the area of the shielding sheet 1901. FIG. 19 shows that a plurality of protruding patterns 1903 are located on one side of the shielding sheet 1901, but according to various embodiments, a plurality of protruding patterns 1903 are disposed on both surfaces of the shielding sheet 1901.

The plurality of protruding patterns 1903 may not be disposed separately from the shielding sheet 1901, but may be integrally formed at the time of injection. That is, the shielding sheet 1901 may be manufactured in a form including a plurality of protruding patterns 1903.

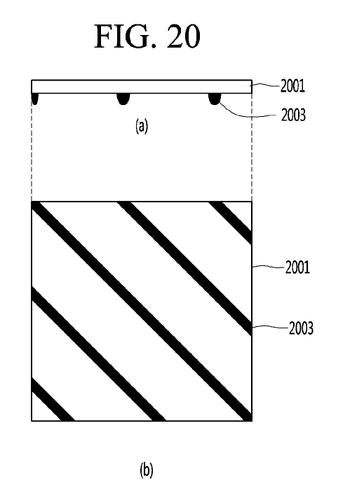

FIG. 20 shows a pattern of a shielding member included in a wireless power transmitter or a wireless power receiver according to another embodiment.

FIG. 20A is a side view of a shielding sheet 2001 including a plurality of protruded patterns 2003 according to another embodiment. FIG. 20B is a top view of a shielding sheet 2001 including a plurality of protruded patterns 2003 according to another embodiment.

Referring to FIGS. 20A and 20B, the shielding sheet 2001 may include a plurality of protruding patterns 2003 in a quadrangular shape. The shielding sheet 2001 can increase the heat releasing efficiency by enlarging the surface area through a plurality of protruding patterns 2003 of the quadrangular shape.

The height of the plurality of protruding patterns 2003 may be less than half the height of the shielding sheet 2001. The area of the plurality of protruding patterns 2003 may be less than half the area of the shielding sheet 2001. FIG. 20 shows that a plurality of protruding patterns 2003 are located on one side of the shielding sheet 2001, but according to various embodiments, the plurality of protruding patterns 2003 are disposed on both surfaces of the shielding sheet 2001.

The plurality of protruding patterns 2003 may not be formed separately from the shielding sheet 2001, but may be integrally formed at the time of injection. That is, the shielding sheet 2001 can be manufactured in a form including a plurality of protruded patterns 2003.

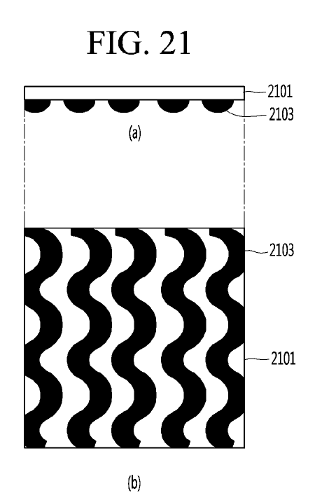

FIG. 21 shows a pattern of a shielding member included in a wireless power transmitter or a wireless power receiver according to another embodiment.

FIG. 21A is a side view of a shielding sheet 2101 including a plurality of protruding patterns 2103 according to another embodiment. FIG. 21B is a top view of a shielding sheet 2101 including a plurality of protruded patterns 2103 according to an embodiment.

Referring to FIGS. 21A and 21B, the shielding sheet 2101 may include a plurality of protruding patterns 2103 having a wavy shape. The shielding sheet 2101 can increase the heat releasing efficiency by extending the surface area through a plurality of protruding patterns 2103 having a wavy shape.

The height of the plurality of protruding patterns 2103 may be less than ½ of the height of the shielding sheet 2101. The area of the plurality of protruding patterns 2103 may be 50% to 100% of the area of the shielding sheet 2101.

The plurality of protruding patterns 2103 may not be separated from the shielding sheet 2101, but may be integrally formed at the time of injection. That is, the shielding sheet 2101 may be manufactured in a form including a plurality of protruding patterns 2103.

The number of the plurality of protruding patterns 2103 may be 10 or less. According to various embodiments, the number of the plurality of protruding patterns 2103 may exceed ten.

According to various embodiments, the height of the plurality of protruding patterns 2103 may exceed ½ of the height of the shielding sheet 2101. In addition, the area of the plurality of protruding patterns 2103 may be less than 50% of the area of the shielding sheet 2101.

FIG. 21 shows that a plurality of protruding patterns 2103 are located on one side of the shielding sheet 2101. However, according to various embodiments, a plurality of protruding patterns 2103 are disposed on both surfaces of the shielding sheet 2101.

In FIG. 21, a plurality of protruding patterns 2103 are shown in an elliptical shape having a convex upper surface, but the shapes of the plurality of protruding patterns 2103 may be varied according to various embodiments. For example, the cross-section of the plurality of protruding patterns 2103 may be a shape having a concave upper surface and an oval shape. In addition, the cross-section of the plurality of protruding patterns 2103 may be triangular. In addition, the cross-section of the plurality of protruding patterns 2103 may have a trapezoidal shape with a narrow upper surface.

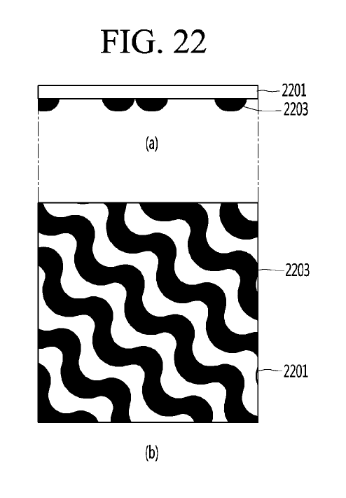

FIG. 22 illustrates a pattern of a shielding member included in a wireless power transmitter or a wireless power receiver according to another embodiment.

FIG. 22A is a side view of a shielding sheet 2201 including a plurality of protruding patterns 2203 according to another embodiment. FIG. 22B is a top view of a shielding sheet 2201 including a plurality of protruding patterns 2203 according to another embodiment.

Referring to FIGS. 22A and 22B, the shielding sheet 2201 may include a plurality of protruding patterns 2203 having a wavy line shape. The shielding sheet 2201 can increase the heat releasing efficiency by enlarging the surface area through a plurality of protruding patterns 2203 in the form of wavy lines.

The height of the plurality of protruding patterns 2203 may be less than ½ of the height of the shielding sheet 2201. The area of the plurality of protruding patterns 2203 may be 50% to 100% of the area of the shielding sheet 2201.

The number of the plurality of protruding patterns 2203 may be 10 or less. According to various embodiments, the number of the plurality of protruding patterns 2203 may exceed ten.

According to various embodiments, the height of the plurality of protruding patterns 2203 may exceed ½ of the height of the shielding sheet 2201. The area of the plurality of protruding patterns 2203 may be less than 50% of the area of the shielding sheet 2201.

The plurality of protruding patterns 2203 may not be separated from the shielding sheet 2201, but may be formed integrally with the shielding sheet 2201 at the time of injection. That is, the shielding sheet 2201 may be manufactured in a form including a plurality of protruding patterns 2203.

FIG. 22 shows that a plurality of protruding patterns 2203 are located on one side of the shielding sheet 2201. According to various embodiments, the plurality of protruding patterns 2203 may be disposed on both surfaces of the shielding sheet 2201.

In FIG. 22, a plurality of protruding patterns 2203 have a cross-section of an elliptical shape with a convex upper surface, but the shapes of the plurality of protruding patterns 2203 may vary according to various embodiments. For example, the cross-section of the plurality of protruding patterns 2203 may be a concave, oval-shaped, top surface. In addition, the cross-section of the plurality of protruding patterns 2203 may be triangular. In addition, the cross-section of the plurality of protruding patterns 2203 may have a trapezoidal shape with a narrow upper surface.

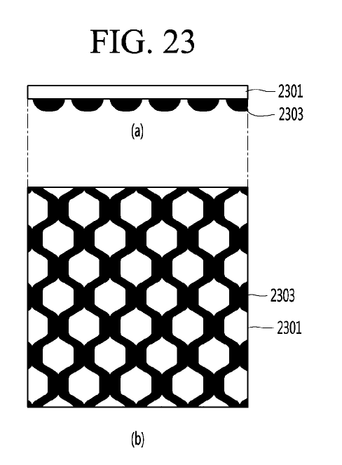

FIG. 23 illustrates a pattern of a shielding member included in a wireless power transmitter or a wireless power receiver according to another embodiment.

FIG. 23A is a side view of a shielding sheet 2301 including a plurality of protruded patterns 2303 according to another embodiment. FIG. 23B is a top view of a shielding sheet 2301 including a plurality of protruded patterns 2303 according to another embodiment.

Referring to FIGS. 23A and 23B, the shielding sheet 2301 may include a plurality of protruding patterns 2303 having a honeycomb shape. The shielding sheet 2301 may expand the surface area through a plurality of honeycomb protruding patterns 2303 to increase the heat releasing efficiency.

The height of the plurality of protruding patterns 2303 may be less than ½ of the height of the shielding sheet 2301. The area of the plurality of protruding patterns 2303 may be 50% to 100% of the area of the shielding sheet 2301.

The number of the plurality of protruding patterns 2303 may be 10 or less. According to various embodiments, the number of the plurality of protruding patterns 2303 may exceed ten.

According to various embodiments, the height of the plurality of protruded patterns 2303 may exceed ½ of the height of the shielding sheet 2301. In addition, the area of the plurality of protruding patterns 2303 may be less than 50% of the area of the shielding sheet 2301.

The plurality of protruding patterns 2303 may not be disposed separately from the shielding sheet 2301, but may be integrally formed at the time of injection. That is, the shielding sheet 2301 may be manufactured in a form including a plurality of protruding patterns 2303.

FIG. 23 shows that a plurality of protruding patterns 2303 are located on one side of the shielding sheet 2301. However, according to various embodiments, the plurality of protruding patterns 2303 are disposed on both surfaces of the shielding sheet 2301.

FIG. 23, a plurality of protruding patterns 2303 have a cross section of an elliptical shape with a convex upper surface. However, the shapes of the plurality of protruding patterns 2303 may vary according to various embodiments. For example, the cross-section of the plurality of protruding patterns 2303 may be in the form of a concave oval-shaped upper surface. In addition, the cross-section of the plurality of protruding patterns 2303 may be triangular. In addition, the cross section of the plurality of protruding patterns 2303 may be a trapezoidal shape with a narrow upper surface.

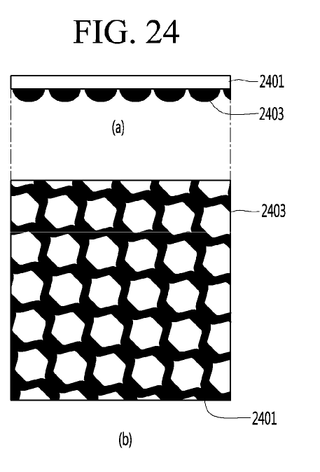

FIG. 24 illustrates a pattern of a shielding member included in a wireless power transmitter or a wireless power receiver according to another embodiment.

FIG. 24A is a side view of a shielding sheet 2401 including a plurality of protruded patterns 2403 according to another embodiment. FIG. 24B is a top view of a shielding sheet 2401 including a plurality of protruding patterns 2403 according to another embodiment.

Referring to FIGS. 24A and 24B, the shielding sheet 2401 may include a plurality of protruding patterns 2403 having a tetragonal honeycomb. The shielding sheet 2401 can increase the heat releasing efficiency by extending the surface area through a plurality of protruding patterns 2403 of the tetragonal honeycomb.

The height of the plurality of protruding patterns 2403 may be less than ½ of the height of the shielding sheet 2401. The area of the plurality of protruding patterns 2403 may be 50% to 100% of the area of the shielding sheet 2401.

The number of the plurality of protruding patterns 2403 may be 10 or less. According to various embodiments, the number of the plurality of protruding patterns 2403 may exceed ten.

According to various embodiments, the height of the plurality of protruding patterns 2403 may exceed ½ of the height of the shielding sheet 2401. In addition, the area of the plurality of protruding patterns 2403 may be less than 50% of the area of the shielding sheet 2401.

The plurality of protruding patterns 2403 may not be separated from the shielding sheet 2401, but may be integrally formed at the time of injection. That is, the shielding sheet 2401 may be manufactured in a form including a plurality of protruding patterns 2403.

FIG. 24 shows that the plurality of protruding patterns 2403 are located on one side of the shielding sheet 2401. However, according to various embodiments, the plurality of protruding patterns 2403 are disposed on both surfaces of the shielding sheet 2401.

In FIG. 24, the cross-section of a plurality of protruding patterns 2403 is shown as an ellipse having a convex upper surface, but the shapes of the plurality of protruding patterns 2403 may be varied according to various embodiments. For example, the cross-section of the plurality of protruding patterns 2403 may have a shape in which the upper surface is concave and oval-shaped. In addition, the cross-section of the plurality of protruding patterns 2403 may be triangular. In addition, the cross-section of the plurality of protruding patterns 2403 may have a trapezoidal shape with a narrow upper surface.

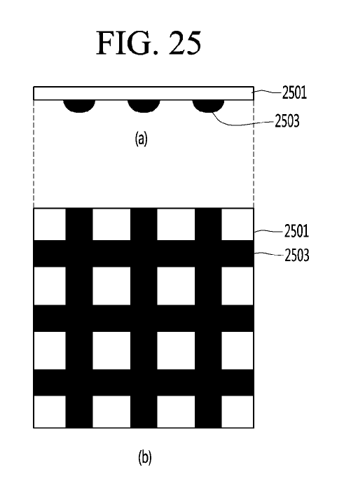

FIG. 25 shows a pattern of a shielding member included in a wireless power transmitter or a wireless power receiver according to another embodiment.

FIG. 25A is a side view of a shielding sheet 2501 including a plurality of protruding patterns 2503 according to another embodiment. FIG. 25B is a top view of a shielding sheet 2501 including a plurality of protruding patterns 2503 according to another embodiment.

In FIGS. 25A and 25B, the shielding sheet 2501 may include a plurality of protruding patterns 2503 of an intersecting type. The shielding sheet 2501 can increase the heat releasing efficiency by enlarging the surface area through the plurality of protruding patterns 2503 of the crossing type.

The height of the plurality of protruding patterns 2503 may be less than ½ of the height of the shielding sheet 2501. The area of the plurality of protruding patterns 2503 may be 50% to 100% of the area of the shielding sheet 2501.

The number of the plurality of protruding patterns 2503 may be 10 or less. According to various embodiments, the number of the plurality of protruding patterns 2503 may exceed ten.

According to various embodiments, the height of the plurality of protruding patterns 2503 may exceed one half of the height of the shielding sheet 2501. In addition, the area of the plurality of protruding patterns 2503 may be less than 50% of the area of the shielding sheet 2501.

The plurality of protruding patterns 2503 may not be separated from the shielding sheet 2501, but may be integrally formed at the time of injection. That is, the shielding sheet 2501 may be manufactured in a form including a plurality of protruding patterns 2503.

FIG. 25 shows that a plurality of protruding patterns 2503 are located on one side of the shielding sheet 2501. However, according to various embodiments, the plurality of protruding patterns 2503 are disposed on both surfaces of the shielding sheet 2501.

In FIG. 25, a plurality of protruding patterns 2503 are shown in the shape of an ellipse having a convex upper surface, but the shapes of the plurality of protruding patterns 2503 may vary according to various embodiments. For example, the cross-section of the plurality of protruding patterns 2503 may have a concave, oval-shaped top surface. In addition, the cross-section of the plurality of protruding patterns 2503 may be triangular. In addition, the cross-section of the plurality of protruding patterns 2503 may have a trapezoidal shape with a narrow upper surface.

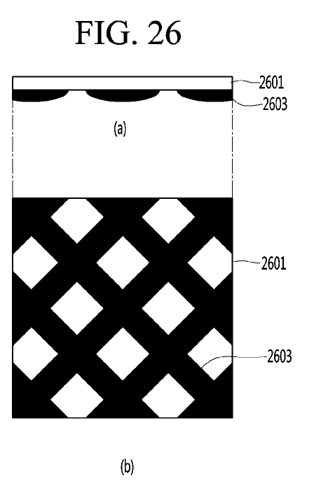

FIG. 26 shows a pattern of a shielding member included in a wireless power transmitter or a wireless power receiver according to another embodiment.

FIG. 26A is a side view of a shielding sheet 2601 including a plurality of protruding patterns 2603 according to an embodiment. FIG. 26B is a top view of a shielding sheet 2601 including a plurality of protruding patterns 2603 according to an embodiment.

Referring to FIGS. 26A and 26B, the shielding sheet 2601 may include a plurality of protruding patterns 2603 crossing obliquely. The shielding sheet 2601 can increase the heat releasing efficiency by enlarging the surface area through a plurality of protruding patterns 2603 crossing obliquely. The height of the plurality of protruding patterns 2603 may be less than ½ of the height of the shielding sheet 2601. The area of the plurality of protruding patterns 2603 may be 50% to 100% of the area of the shielding sheet 2601.

The number of the plurality of protruding patterns 2603 may be 10 or less. According to various embodiments, the number of protruding patterns 2603 may exceed ten.

According to various embodiments, the height of the plurality of protruding patterns 2603 may exceed one half of the height of the shielding sheet 2601. In addition, the area of the plurality of protruding patterns 2603 may be less than 50% of the area of the shielding sheet 2601.

The plurality of protruding patterns 2603 may not be separated from the shielding sheet 2601, but may be formed integrally with each other at the time of injection. That is, the shielding sheet 2601 may be manufactured in a form including a plurality of protruding patterns 2603.

FIG. 26 shows that a plurality of protruding patterns 2603 are located on one side of the shielding sheet 2601. However, according to various embodiments, the plurality of protruding patterns 2603 are disposed on the shielding sheet 2601.

FIG. 26 shows a cross section of a plurality of protruding patterns 2603 in an elliptic shape having a convex upper surface. However, the shapes of the plurality of protruding patterns 2603 may vary according to various embodiments. For example, the cross-section of the plurality of protruding patterns 2603 may be a concave oval-shaped top surface. In addition, the cross-section of the plurality of protruding patterns 2603 may be triangular. In addition, the cross-section of the plurality of protruding patterns 2603 may have a trapezoidal shape with a narrow upper surface.

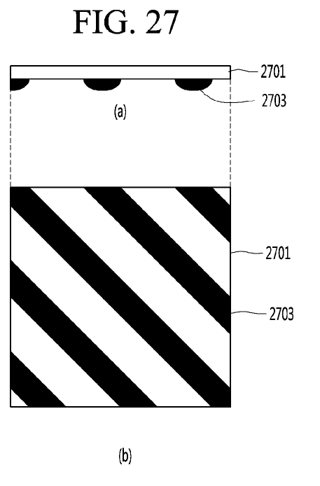

FIG. 27 illustrates a pattern of a shielding member included in a wireless power transmitter or a wireless power receiver according to another embodiment.

FIG. 27A is a side view of a shielding sheet 2701 including a plurality of protruded patterns 2703 according to another embodiment. FIG. 27B is a top view of a shielding sheet 2701 including a plurality of protruded patterns 2703 according to an embodiment.

Referring to FIGS. 27A and 27B, the shielding sheet 2701 may include a plurality of protruding patterns 2703 of a quadrangular shape. The shielding sheet 2701 can increase the heat releasing efficiency by enlarging the surface area through a plurality of protruding patterns 2703 in the shape of a line.

The height of the plurality of protruding patterns 2703 may be less than ½ of the height of the shielding sheet 2701. The area of the plurality of protruding patterns 2703 may be 50% to 100% of the area of the shielding sheet 2701.

The number of the plurality of protruding patterns 2703 may be 10 or less. According to various embodiments, the number of the plurality of protruding patterns 2703 may exceed ten.

According to various embodiments, the height of the plurality of protruding patterns 2703 may exceed ½ of the height of the shielding sheet 2701. The area of the plurality of protruding patterns 2703 may be less than 50% of the area of the shielding sheet 2701.

The plurality of protruding patterns 2703 may not be separated from the shielding sheet 2701, but may be integrally formed at the time of injection. That is, the shielding sheet 2701 may be manufactured in a form including a plurality of protruding patterns 2703.

FIG. 27 shows that a plurality of protruding patterns 2703 are located on one side of the shielding sheet 2701, but according to various embodiments, the plurality of protruding patterns 2703 are disposed on the shielding sheet 2701.

FIG. 27 shows a plurality of protruding patterns 2703 having a top surface convex in cross section, but the shape of the plurality of protruding patterns 2703 may vary according to various embodiments. For example, the cross-section of the plurality of protruding patterns 2703 may be a shape in which the upper surface is concave oval-shaped. In addition, the cross-section of the plurality of protruding patterns 2703 may be triangular. In addition, the cross section of the plurality of protruding patterns 2703 may be a trapezoidal shape with a narrow upper surface.

According to various embodiments, one surface of the shielding member may include at least one of the plurality of patterns shown in FIGS. 14 to 27. For example, one surface of the shield may be divided into a plurality of portions. At this time, a plurality of portions of one surface of the shielding member may include at least one of the plurality of patterns shown in FIGS. 14 to 27.

Further, one surface and the other surface of the shielding member may include at least one of the plurality of patterns shown in FIGS. 14 to 27. The one surface and the other surface of the shielding member may include patterns having different shapes. For example, one surface of the shielding member may have a pattern shape of FIG. 21, and the other surface of the shielding member may have a pattern shape of FIG. 22.

FIGS. 6 to 27 are merely for convenience of explanation of the invention, and the invention is not limited thereto. That is, according to various embodiments, the shape, size, arrangement, and configurations of the shielding member may be varied.

1. A wireless power transmitter for wirelessly transmitting power to a wireless power receiver comprises:
a control circuit configured to control the wireless power transmitter;
at least one transmission coil configured to transmit the power to the wireless power receiver; and
a shielding member disposed between the transmission coil and the control circuit,
wherein the shielding member is one sheet combined with a heat release sheet and a shielding sheet.

2. The wireless power transmitter of claim 1, wherein the heat release sheet is a silicone polymer including ceramic powder.

3. The wireless power transmitter of claim 1,
wherein the heat release sheet includes a protective sheet and a metal sheet, and
wherein the metal sheet is disposed on top of the shielding sheet, and the protective sheet is disposed on top of the metal sheet.

4. The wireless power transmitter of claim 1, wherein the shielding sheet is a rubber including magnetic metal powder.

5. The wireless power transmitter of claim 1, wherein the shielding member is bonded to the control circuit and the transmission coil via an adhesive.

6. A wireless power receiver for wirelessly receiving power from a wireless power transmitter comprises:
a control circuit configured to control the wireless power receiver;
at least one receiving coil configured receive the power from the wireless power transmitter; and
a shielding member disposed between the receiving coil and the control circuit,
wherein the shielding member is a sheet combined with a heat release sheet and a shielding sheet.

7. The wireless power receiver of claim 6, wherein the heat release sheet is a silicone polymer including ceramic powder.

8. The wireless power receiver of claim 6,
wherein the heat release sheet includes a protective sheet and a metal sheet, and
wherein the metal sheet is disposed on top of the shielding sheet, and the protective sheet is disposed on top of the metal sheet.

9. The wireless power receiver of claim 6, wherein the shielding sheet is a rubber including magnetic metal powder.

10. The wireless power receiver of claim 7, wherein the shielding member is bonded to the control circuit and the receiving coil via an adhesive.

11. A wireless power transmitter for wirelessly transmitting power to a wireless power receiver, comprising:
a control circuit configured to control the wireless power transmitter;
at least one transmission coil configured to transmit the power to the wireless power receiver; and
a shielding member disposed between the transmission coil and the control circuit,
wherein the shielding member includes a shielding sheet, and
wherein the shielding sheet includes a plurality of protruding patterns.

12. The wireless power transmitter of claim 11, wherein the plurality of protruding patterns are disposed in a longwise direction.

13. The wireless power transmitter of claim 11, wherein the plurality of protruding patterns are disposed on one of an upper surface and a lower surface of the shielding sheet.

14. The wireless power transmitter of claim 11, wherein the plurality of protruding patterns are spaced apart from each other.

15. The wireless power transmitter of claim 11, wherein the plurality of protruding patterns are disposed in contact with each other.

16. The wireless power transmitter of claim 11, wherein the plurality of protruding patterns have a round surface from a highest peak point toward the shielding sheet.

17. The wireless power transmitter of claim 16, wherein one of the control circuit and the transmission coil contacts the highest peak point of the protruding pattern.

18. The wireless power transmitter of claim 11, further comprising:
a space surrounded by the control circuit and the protruding pattern.

19. The wireless power transmitter of claim 11, wherein the height of the plurality of protruding patterns is less than ½ of the height of the shielding sheet.

20. The wireless power transmitter of claim 11, wherein the area of the plurality of protruding patterns is 50% to 100% of the area of the shielding sheet.
